(19) United States
(12) Patent Application Publication
(10) Pub. No.: US 2026/0009278 A1
(43) Pub. Date: Jan. 8, 2026

(54) WINDOW LIFTER ASSEMBLY FOR A MOTOR VEHICLE

(71) Applicant: Brose Fahrzeugteile SE & Co. Kommanditgesellschaft, Bamberg, Bamberg (DE)

(72) Inventors: Thomas KRIEGER, Breitenguessbach (DE); Julian SCHMITT, Reckendorf (DE); Georg SIEDERSLEBEN, Bamberg (DE); Simon HERBST, Bad Staffelstein (DE)

(73) Assignee: Brose Fahrzeugteile SE & Co. Kommanditgesellschaft, Bamberg, Bamberg (DE)

(21) Appl. No.: 19/325,291

(22) Filed: Sep. 10, 2025

Related U.S. Application Data
(63) Continuation of application No. PCT/EP2024/055861, filed on Mar. 6, 2024.

(30) Foreign Application Priority Data
Mar. 10, 2023 (DE) 10 2023 202 176.5

(51) Int. Cl. E05F 15/689; E05D 15/16; F16B 39/284

(52) U.S. Cl. CPC E05F 15/6909; E05D 15/165; E05Y 2201/48; E05Y 2201/664; E05Y 2201/71; E05Y 2600/632; E05Y 2900/55; F16B 39/284

(57) ABSTRACT

A window lifter assembly for a motor vehicle, comprising an electric-motor-powered cable drive having a housing, and comprising a guide rail to which the cable drive is connected via a screw fastening. The guide rail has at least one passage opening for a screw element having a screw head, which passage opening is aligned with a screw opening of the cable drive and/or of its housing. At least one contact lug for contact with the screw head extends out of the guide rail in a region of the passage opening.

This nonprovisional application is a continuation of International Application No. PCT/EP2024/055861, which was filed on Mar. 6, 2024, and which claims priority to German Patent Application No. 10 2023 202 176.5, which was filed in Germany on Mar. 10, 2023, and which are both herein incorporated by reference.

### FIELD OF THE INVENTION

The invention relates to a window lifter assembly for a motor vehicle, in particular for a vehicle door, comprising an electric-motor-powered cable drive having a housing, and comprising a guide rail to which the cable drive is connected, in particular by means of a screw fastening.

### DESCRIPTION OF THE BACKGROUND

A vehicle door of a motor vehicle usually has a door frame that is often referred to as a door shell and a door outer panel forming the door outer skin of the vehicle door as well as an interior door trim connected to the door frame. A cavity is formed between the door outer skin (door outer panel) and the interior door trim as an assembly space for functional elements or functional components of the vehicle door.

The functional components of a vehicle door, such as a window lifter or a window lifter assembly, a pressure sensor for a side airbag, door control electronics, a loudspeaker, a door lock, control units or the like, are usually pre-assembled on a carrier plate of a door module also called an assembly support. The equipped carrier plate is then attached to the door shell under the cover of a door frame infill that also serves as a mounting opening. The door module, as a carrier plate equipped in particular with the window lifter (the window lifter assembly), is also used in particular to separate a wet space formed between the door outer skin (the door outer panel) and the door module by a dry space of the vehicle door formed between the door module and the interior door trim (the door inner panel).

Such a window lifter for a vehicle door, for example, is designed with a cable system for raising and lowering a (window) pane. Single-strand window lifters with only one guide rail (single-stranded application) or double-strand window lifters with two parallel guide rails (double-stranded application) can be used. Such a window lifter, also known as a cable window lifter, has at least one so-called rail slider or (window) driver, which is connected to the (window) pane and guided along the at least one guide rail by means of a driven cable system. The cable system of the window lifter generally has a cable pull formed by at least one traction cable, which on the one hand wraps around a cable drum with, typically, several windings and is wound up and unwound by it, and on the other hand is guided to the, or each, (window) driver or rail slider with multiple deflections and fixed there.

The window lifter drive or cable drive is typically an electric motor with a coupled gearbox, in particular a worm gear as a 90° deflection drive. The electric motor cable drive can be arranged on the wet space side (wet space motor) or on the dry space side (dry space motor). The electric-motor-powered cable drive is typically installed by screw connection to a housing assembly, which has a housing part that accommodates the gearbox and a housing part that accommodates the cable drum coupled to the cable drive. The screw connection of the housing parts can be carried out via passage openings of the carrier plate by means of screw elements (screws). Such a housing assembly of an electric-motor-powered cable drive of a vehicle window lifter is known, for example, from DE 10 2016 212 041 B4, which is incorporated herein by reference.

From DE 20 2011 100 077 U1, which is incorporated herein by reference, a window lifter assembly is known, in which an electric-motor-powered cable drive is connected on the one hand to a guide rail and on the other hand to a carrier plate, for example. In this case, the guide rail is fastened with a cable drive housing and with a motor housing of the electric motor drive, and the cable drive housing is fastened at another fastening point, for example the carrier plate, by means of similar screw elements. These are designed in flat head geometry with countersunk head geometry on the shaft side.

It has been found that the screw connection between the guide rail and the cable drive housing or the motor or gearbox housing of the electric motor cable drive of the window lifter or window lifter assembly may come loose. When using a countersunk head geometry, the countersunk head is intended to prevent a relative movement between components involved in the connection. In particular when a flat head geometry is used, especially as a result of settlement behavior, a relative movement of the cable drive in relation to the guide rail may occur for operational reasons, which is undesirable, for example, because of noise generation. Such relative motion, which cannot be ruled out even if a countersunk head geometry is used, typically occurs when the screw used loosens even slightly.

### SUMMARY OF THE INVENTION

It is therefore an object of the invention to provide a particularly suitable window lifter assembly, in particular for a vehicle door of a motor vehicle. In particular, a secure screw connection between the guide rail and the electric-motor-powered cable drive of the window lifter assembly is specified or provided.

The window lifter assembly may be intended for a motor vehicle, in particular for a motor vehicle door, and can comprise an electric-motor-powered cable drive and a guide rail, to which the cable drive is connected. The electric motor cable drive comprises a housing or a housing assembly with a motor or gearbox housing and with a cable drive housing. The guide rail can be a correspondingly shaped metal part or metal sheet, whereas the housing (cable drive or gearbox housing) is preferably made of plastic. The cable drive is connected to the guide rail by means of a screw fastening.

The guide rail can comprise at least one passage opening for a screw element having a screw head, which passage opening is aligned with a screw opening of the cable drive or its housing. Preferably, two such passage openings, which align with corresponding screw openings of the cable drive or its housing, are provided on the rail side for two screw elements.

At least one spring or contact lug can be extended out of the guide rail in the region of the respective passage opening. A pair of lugs is preferred. The contact lug or the pair of lugs is preferably used for the lateral or circumferential contact with the screw head of the corresponding screw element. This reliably prevents the screw element from loosening. In particular, a relative movement of the cable drive in relation to the guide rail is prevented.

The at least one contact lug can be axially extended out in relation to a screw rotation axis of the screw element. In other words, a spring-loaded contact surface has been altered from the guide rail, especially in terms of bending or punch-bending technology. At least one contact lug is preferably spring-elastic. Appropriately, the at least one contact lug is molded as a punched bending part or as a double punch-bending component from the guide rail.

Appropriately, the at least one contact lug can be designed as a molded part with an inverted or upside-down V- or U-shape. The molded part has a fixed leg molded to the guide rail and a free or spring leg which in turn rests against the screw head of the screw element, and the free end of which protrudes or is guided against the passage opening on the rail side or its opening edge.

Two (diametrically) opposed contact lugs can be provided for the screw head of the screw element in the area of the passage opening of the guide rail.

A particularly advantageous method for the production of the rail-side contact lugs, including the passage opening for the screw element or the fastening screw, is that an oval or rectangular hole, in particular with rounded (inner) corners, is first embedded in the guide rail at the designated connection or screw mounting point. Subsequently, in the area of the long sides of this rail hole, a material area of the guide rail corresponding to the total length and width of the respective contact lug is pressed or compressed from its rail plane in the area of the hole or the subsequent passage opening into a parallel plane. In the next step, this pressed material area forms the, or each, contact lug, preferably by flexing (bending). Then, in a next step, the passage opening for the screw element, which is preferably circular, is produced, in particular by punching.

Preferably as a result of this method, at least one recess, in particular rectangular, with parallel long sides and with a narrow side on which the contact lug is molded, can be molded at the passage opening of the guide rail. In the case of radially opposite contact lugs of a pair of tabs, in terms of the screw rotation axis, their distance, i.e., the distance of their free or spring legs to one another is adjusted to the diameter of the screw head of the screw element in such a way that the contact lugs or their free legs rest against the screw head with a spring force or in a spring-elastic manner. The frictional forces caused in this process reliably prevent loosening of the screw element, which is mounted, screwed, or bolted as intended.

The housing of the cable drive may have a first housing part and a second housing part. These housing parts can be suitably screwed together at the same time on the guide rail via, for example, the two screw elements as part of the screw fastening process. The first part of the housing is preferably a gearbox in which a worm wheel is mounted so as to rotate, which meshes with a worm gear, which is connected to a motor shaft of the electric motor in a torsion-proof manner. Instead of such a worm gear, a different gear may also be provided, such as a helical or bevel gear, in particular as a 90° deflection gear. The second part of the housing is preferably a cable drive housing, in which a cable drum is rotatably arranged and coupled to the gearbox. The screw opening into which the respective screw element is screwed, is suitably provided in the first housing part. The screw opening of the other (second) housing part is then suitably designed as a passage opening.

The cable drive housing can also have at least one positioning pin, which corresponds to a positioning opening of the guide rail. The positioning pin, which is equipped in particular with scraper ribs, is used for the pre-fastening and/or pre-positioning of the cable drive to the guide rail in that the positioning pin passes through the corresponding positioning opening of the guide rail, in particular by creating a form-fitting connection.

The screw element can have practically any geometry. Particularly advantageously, the screw element can be a flat head screw with a round screw head, especially with a flat ball top. A cylindrical shaft section connects directly to the screw head. In other words, only flat head screws without countersunk head geometry are suitably used, which is made possible because of the spring-elastic contact lugs of the guide rail for the flat heads of such screw elements, while at the same time securing them against a relative movement between the electric-motor-powered cable drive and the guide rail of the window lifter assembly.

This, i.e., a window lifter containing the window lifter assembly, may have a carrier plate to which the guide rail and, in particular, partially or in some areas, the housing of the cable drive is additionally attached, in particular screw-fastened. The carrier plate can be located in a vehicle door and separate a dry space from a wet space. The window lifter assembly can also be arranged in the wet space, for example.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows in an exploded representation, a window lifter assembly comprising a guide rail and an electric-motor-powered cable drive that can be mounted on said guide rail by means of screw elements,

FIG. 2 shows in a perspective representation, the cable drive mounted on the guide rail with a view to contact lugs for screw elements in the area of passage openings for the screw elements,

FIG. 3 shows in a plan view, sections of the guide rail with two passage openings for the screw elements, which openings have contact lugs,

FIG. 4 shows a section IV of FIG. 3 in a larger scale in the area of one of the passage openings with the contact lugs assigned to them,

FIG. 5 shows in a schematic diagram, a rail-side surrounding area of a rail-side passage opening with a screw element seated in it and attached to the head of the contact lugs by a screw head, and

FIGS. 6a to 6d schematically show a sequence of punch-bending steps for manufacturing the rail-side contact lugs and the rail-side passage opening for the respective screw element.

### DETAILED DESCRIPTION

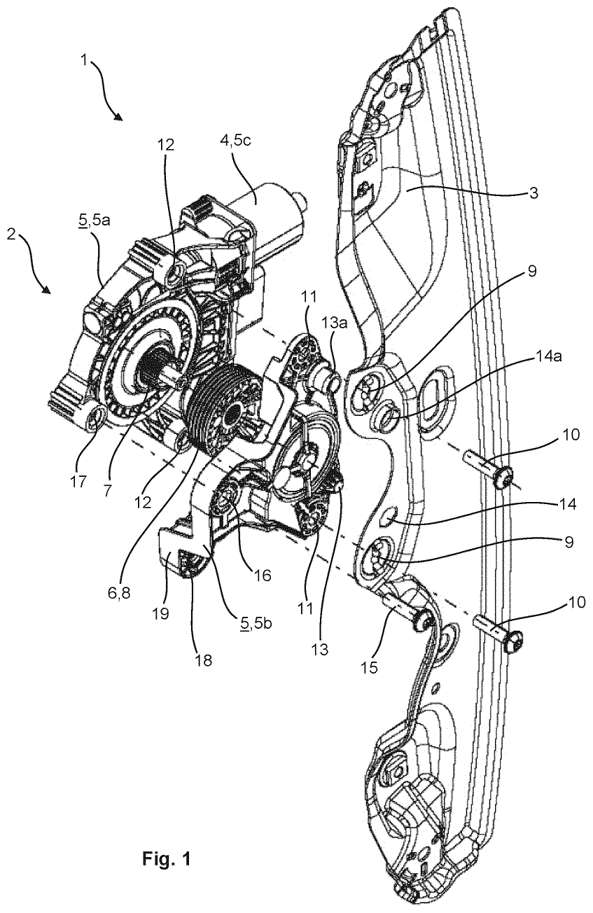

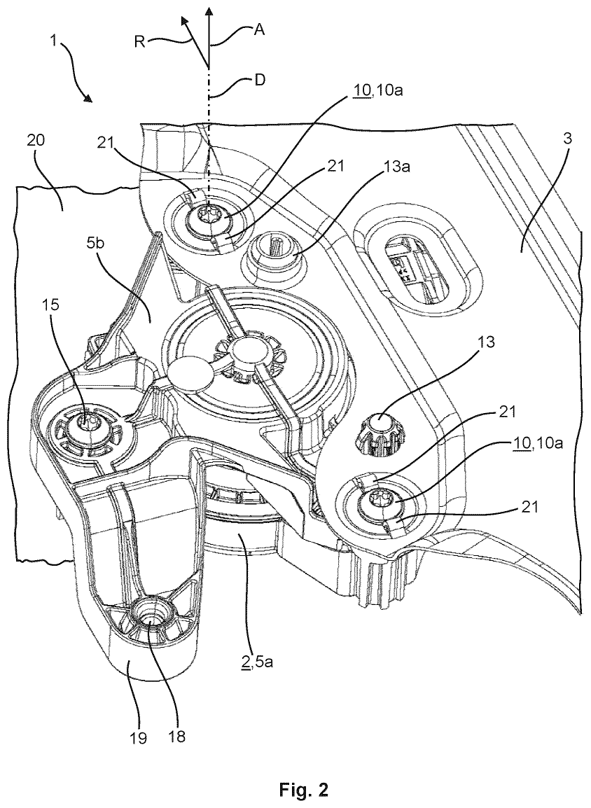

In an exploded representation or in sections in a top or side view, FIGS. 1 and 2 show a window lifter assembly 1 comprising an electric motor cable drive 2 and comprising a guide rail 3, to which the cable drive 2 is connected by means of a screw fastening. The cable drive 2 has an electric motor 4 and a housing 5, which is formed here by a gear housing 5a and a cable drive housing 5b or includes these housing parts 5a, 5b. The guide rail 3 is a (punch-bending) metal part. The housing 5, here the cable drive housing 5b and the gear housing 5a, are plastic parts. The electric motor 4 has a motor housing 5c designed as a so-called pole pot.

The window lifter assembly 1 is part or a component of a window lifter (window lifter system), which is not described in more detail here, in which the guide rail 3 specifies a guide path for a window pane, in particular of a vehicle door of a motor vehicle. The window pane is adjusted by means of a flexible traction cable, which is wound or unwound by a cable drum 6 driven by means of the electric motor 4 and a gearbox coupled to it. The cable drum 6 is coupled to a gear wheel 7, which is arranged so as to rotate in the cable drive housing 5b. A (non-visible) worm wheel coupled to the gear wheel 7 is mounted in the gearbox housing 5a in a rotatable manner and meshes there in an unspecified manner with a worm which is connected non-rotatably, or fixed with respect to the shaft, to a motor shaft of the electric motor 4.

The traction cable, which is inserted with several windings in a cable groove 8 circumferentially surrounding the cable drum 6 in a threaded or screw-like manner, is connected in an unspecified manner to a rail slider or driver slidingly guided by the guide rail 2, which slider or driver in turn is connected to the window pane. As a result of a controlled current supply of the electric motor 4, the electric-motor-powered cable drive 2 moves the window pane coupled to it along the adjustment path specified by the guide rail 3 between an open and a closed position.

In the example, the guide rail 3 has two passage openings 9 for one screw element 10 each. The rail-side passage openings 9 align with screw openings 11, 12 of the cable drive housing 5b or the gearbox housing 5a. The screw openings 12 of the gearbox housing 5a are designed here as screw domes, into which the screw elements 10 are screwed with their external threads on the shaft side.

The cable drive housing 5b has a positioning pin 13, which corresponds to a positioning opening 14 of the guide rail 2. The positioning pin 13, which is preferably provided with scraper ribs and molded to the cable drive housing 5b, penetrates the positioning opening 14 of the guide rail 3 in the assembly state of the cable drive 2, in particular by establishing a form-fitting connection. This is used for pre-fastening or pre-positioning of the cable drive 2 on the guide rail 3. In the example, an additional or alternative, in particular round or cylindrical, positioning dome 13a on the cable drive housing 5b and a corresponding positioning opening 14a in the guide rail 2 are provided.

When the cable drive 2 is mounted on the guide rail 3, the screw elements 10 reach through the corresponding passage openings 9 of the guide rail and the screw openings 11 of the cable drive housing 5b, in order to be screwed into the screw openings or domes 12 of the gearbox housing 5a. This attaches the cable drive 2 to the guide rail 3. At the same time, during the screwing process using the screw elements 9, the housing parts 5a and 5b (cable drive and gearbox housing) of the housing 5 of the cable drive 2 are connected to each other. For this purpose, the example provides a further connection point between the housing parts 5a and 5b for an additional screw element 15. This engages in a corresponding screw opening 16 of the cable drive housing 5b and is inserted into a screw opening or into a corresponding screw dome 17 of the gearbox housing 5a.

As can be seen comparatively clearly from FIG. 2, the cable drive housing 5b has a further screw opening 18, which is provided on an angled housing arm or housing boom 19. This provides a further connection point at which or with which the cable drive 2 is additionally attached to a support structure 20, in particular to a door inner panel. The guide rail 3 is also suitably attached to the support structure 20, in particular screw-fastened.

For example, the support structure 20 can also be an (existing) part of a door module which, in addition to the window lifter assembly 1 and other components or parts of a vehicle door, can also have other components mounted on the support structure 20 or mountable aggregates. The support structure 20 separates the so-called wet space formed between said structure and a door outer skin from the dry space between the supporting structure 20, in particular the door inner panel, and a door inner trim. The window lifter assembly 1 can preferably also be located in the wet space.

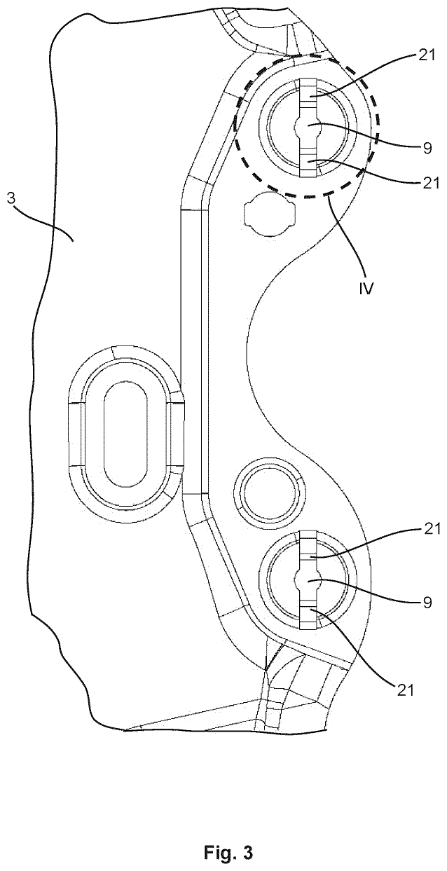

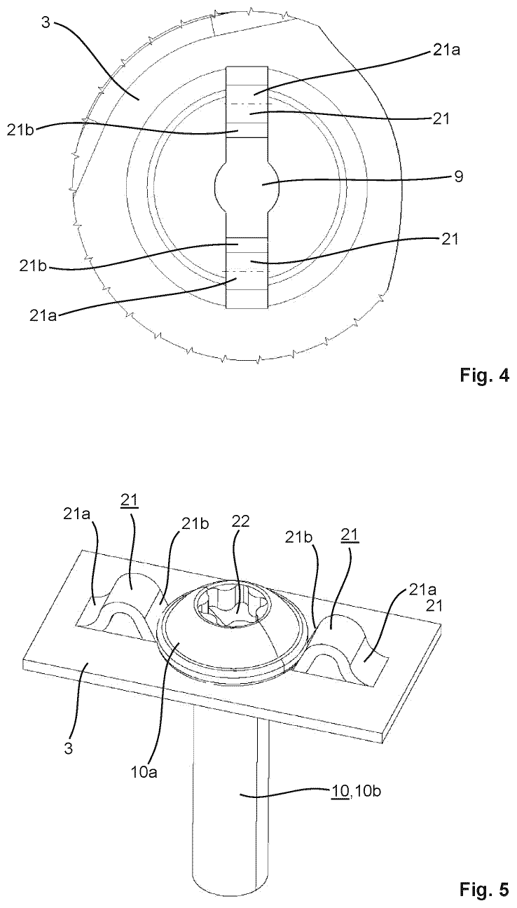

As can be seen in FIG. 2 and also in connection with FIGS. 3 to 5, two spring or contact lugs 21 are provided from the guide rail 3 in the area of the respective passage opening 9 in the example. These contact lugs 21, hereinafter also referred to as a pair of lugs, based on the screw rotation axis D of the corresponding screw element 9 as shown in FIG. 2 or based on the axial direction A and radial direction R shown, are arranged radially opposite each other and are axially extended out in each case. The contact lugs 21 are molded from the guide rail 3 or from its rail or sheet material and are preferably manufactured using the punch-bending process.

The respective contact lug 21 forms a, in particular springy, attachment surface for the screw element 10 or for its screw head 10a. The contact lug 21 or the pair of lugs is used for the lateral or circumferential attachment of a screw head 10a of the corresponding screw element 10. This reliably prevents the screw element 10 from loosening. In particular, a relative movement of the cable drive 2 in relation to the guide rail 3 is prevented.

As can be seen comparatively clearly from FIG. 5, the contact lug 21 is a molded or bent part with a (upside-down or standing on its head) V- or U-shape. Here, FIG. 3 represents a rectangular (material) section of the guide rail 3 in the area of the passage opening 9. The contact lug 21 has a fixed leg 21a molded to the guide rail 3 and, in turn, a free leg or spring leg 21b molded to said fixed leg. With this spring leg 21b, the contact lug 21 rests on the screw head 10a of the screw element 10. The free end of the contact lug 21 or its spring leg 21b is guided against the rail-side passage opening 9 or its opening edge.

In FIG. 5, the screw shaft 10b of the screw element (the screw) 10 can also be seen. The screw shaft 10b of the screw element 10 has an external thread. In the example, the screw element 10 is a flat head screw with a round screw head 10a, in particular with a flat-ball top. The screw head 10a has an inner multi-round as a tool holder 22 in the example. The cylindrical shank section is directly attached to the screw head 10b. In other words, the screw element 10 appropriately has a cylindrical shape without a countersunk head geometry, even in sections, over the entire shaft length of the screw shaft 10a.

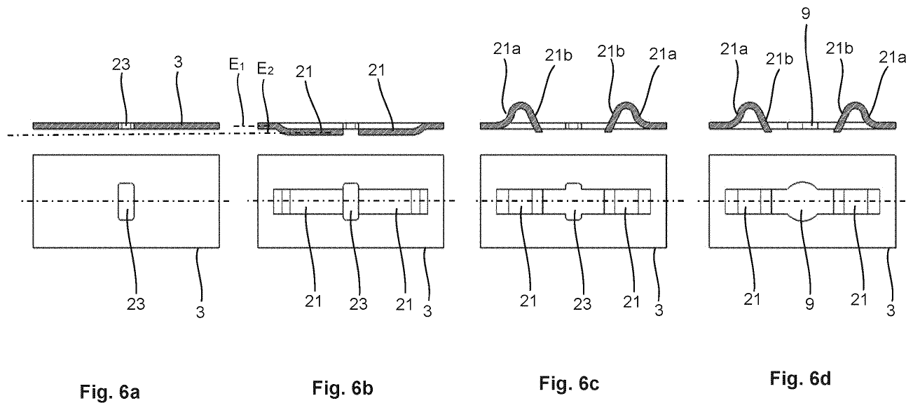

FIGS. 6a to 6c show the method steps for the production of the rail-side contact lugs 21 and the passage opening 9 for the respective screw element 10 or for the flat head screw. In a plan view (bottom) and in a sectional view (top) along the drawn dashed lines, a section or material area of the guide rail 3 in the area of the corresponding passage opening 9 or as a material area around the passage opening 9 are shown.

In FIG. 6a, an oval or rectangular rail hole 23 with rounded (inner) corners is inserted at the intended point of connection or screw assembly point. The hole 23 is inserted into the guide rail 3 as a punched hole by means of a corresponding punching tool.

In the course of the manufacturing or method step illustrated in FIG. 6b, in the area of the long sides of this rail hole 23, in particular by means of a press or punch press tool, a material area of the guide rail corresponding to the total length and width of the respective contact lug 21 is pressed or compressed from its rail plane E₁ in the area of the hole 23 into a parallel plane E₂. The depth of the punch or the distance between the planes E₁ and E₂ corresponds approximately or exactly to the or a single sheet thickness of the guide rail 3 in the area of the hole 23 or the later passage opening 9.

As a result of the manufacturing step or method step illustrated in FIG. 6c, the contact lugs 21, in particular by means of a bending tool, are brought into the desired V- or U-shape. For this purpose, the contact lugs 21 produced in the step according to FIG. 6b from the pressed material area and still elongated there are reshaped accordingly. The respective fixed leg 21a and the spring or attachment leg 21b of the corresponding contact lug 21 are made by bending technology.

In the manufacturing or method step illustrated in FIG. 6c, the circular passage opening 9 for the screw element 10 is produced, in particular by punching. The inner diameter or clearance of the passage opening 9 is adapted to the outer diameter of the screw shaft 10b, preferably with as little play as possible.

As a result, diametrically opposed rectangular recesses with parallel long sides and with a narrow side are formed at the passage opening 9 of the guide rail 3, on which the respective contact lug 21 is molded. In the case of the radially opposed contact lugs 21, their spacing or the distance between their free or spring legs 21b is adapted to the diameter of the screw head 10a of the screw element 10 in such a way that the contact lugs 21 or their free legs 21b are connected to the screw head 10a with sufficient spring force to reliably prevent or block loosening of the screw element 10.

In summary, the invention relates to a window lifter assembly 1, comprising an electric-motor-powered cable drive 2 having a housing 5, 5a, 5b and a guide rail 3 connected to the cable drive 2, comprising a passage opening 9 for a screw element 10 with a screw head 10a which passage opening is aligned with a screw opening 11, 12 of the cable drive 2 and/or its housing 5, wherein in the region of the passage opening 9 at least one contact lug 21 for contact with the screw head 10a is extended out of the guide rail 3.

The invention is not limited to the examples described above. Rather, other variants of the invention can also be derived therefrom by the skilled person without departing from the subject matter of the invention. In particular, all the individual features described in connection with the examples can also be combined with each other in other ways without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A window lifter assembly for a motor vehicle, the window lifter assembly comprising:
an electric motor cable drive having a housing and a guide rail, to which the cable drive is connected;
at least one passage opening provided in the guide rail for a screw element (10) with a screw head, the at least one passage opening being aligned with a screw opening of the cable drive and/or its housing; and
at least one contact lug extending out of the guide rail in a region of the passage opening for lateral or circumferential contact with the screw head.

2. The window lifter assembly according to claim 1, wherein the at least one contact lug is axially extended out in relation to a screw rotation axis of the screw element.

3. The window lifter assembly according to claim 1, wherein the at least one contact lug is spring-elastic.

4. The window lifter assembly according to claim 1, wherein the at least one contact lug is molded as a punch-bending part from the guide rail.

5. The window lifter assembly according to claim 1, wherein the at least one contact lug is molded as a V- or U-shaped part with a fixed leg that is molded to the guide rail and with a free leg or spring leg for attachment to the screw head (of the screw element.

6. The window lifter assembly according to claim 1, wherein in a region of the passage opening of the guide rail, two opposing, extended contact lugs are provided for the screw head of the screw element.

7. The window lifter assembly according to claim 1, wherein the passage opening of the guide rail is radially adjoined by at least one recess or at least one rectangular recess with parallel long sides and with at least one narrow side or narrow sides facing each other, to which the contact lug is molded.

8. The window lifter assembly according to claim 1, wherein the housing of the cable drive comprises a first housing part or a gearbox housing, and a second housing part or a cable drive housing for accommodating a cable drum, and wherein the screw opening is provided to receive the screw element in the first housing part.

9. The window lifter assembly according to claim 1, wherein the screw element or a flat head screw, has a screw head or a round screw head with a flat-ball top, to which a cylindrical shaft section is directly connected.

10. The window lifter assembly according to claim 1, further comprising a carrier plate to which, partially or in sections, the housing of the cable drive is screw-fastened.
